(19) United States
(12) Patent Application Publication
(10) Pub. No.: US 2024/0241750 A1
(43) Pub. Date: Jul. 18, 2024

(54) METHOD OF ABSTRACTION OF DATA AND FUNCTION REFERENCES FOR SOFTWARE SYSTEM RUNTIME RECONFIGURATION

(71) Applicant: THE CHARLES STARK DRAPER LABORATORY, INC., Cambridge, MA (US)

(72) Inventor: Sean CUMMINGS, Cambridge, MA (US)

(21) Appl. No.: 18/411,560

(22) Filed: Jan. 12, 2024

Related U.S. Application Data
(60) Provisional application No. 63/438,719, filed on Jan. 12, 2023.

(51) Int. Cl. G06F 9/48; G06F 9/30

(52) U.S. Cl. CPC G06F 9/4881; G06F 9/3017

(57) ABSTRACT

A method for reconfiguring data referenced during the execution of a software system without the need for prior knowledge of a structured memory layout of the software system, may include parsing qualified software identifiers from the software system and categorizing the qualified software identifiers as either functions or variables, each associated with a name, data type, and data source, correlating the qualified software identifiers with at least one constraint defined by the categorizing, generating an order of execution of the qualified software identifiers based on the constraint, executing tasks defined by the software system according to the order of the qualified software identifiers, in response to a need arising during the execution of the software system, reconfiguring of the order of execution of the qualified software identifiers, and executing tasks defined by the reconfiguration of the order of the qualified software identifiers.

### CROSS-REFERENCE TO RELATED APPLICATIONS

This application claims the benefit of U.S. provisional application Ser. No. 63/438,719 filed Jan. 12, 2023, the disclosure of which is hereby incorporated in its entirety by reference herein.

### TECHNICAL FIELD

The present invention relates to the field of deterministic decision making in software systems.

### BACKGROUND

Computer software executes the compiled control flow in order, evaluating Boolean and logical operations to make decisions. These are common low-level abstractions in most programming languages, resulting in the creation of branching control flow via “IF” or switch-based implementations. These logical operations compare variable data to determine which branch of software control flow to execute during runtime.

### SUMMARY

A method for reconfiguring data referenced during the execution of a software system without the need for prior knowledge of a structured memory layout of the software system, may include parsing qualified software identifiers from the software system and categorizing the qualified software identifiers as either functions or variables, each associated with a name, data type, and data source, correlating the qualified software identifiers with at least one constraint defined by the categorizing, generating an order of execution of the qualified software identifiers based on the constraint, executing tasks defined by the software system according to the order of the qualified software identifiers, in response to a need arising during the execution of the software system, reconfiguring of the order of execution of the qualified software identifiers, and executing tasks defined by the reconfiguration of the order of the qualified software identifiers.

A method for reconfiguring data referenced during the execution of a software system without the need for prior knowledge of a structured memory layout of the software system, may include parsing qualified software identifiers from the software system and categorizing the qualified software identifiers as either functions or variables, each associated with a valid name, data type, and data source, correlating the qualified software identifiers with at least one constraint defined by the categorizing, generating an order of execution of the qualified software identifiers based on the constraint, and executing tasks defined by the software system according to the order of the qualified software identifiers.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates a block diagram of an example mission manager;

FIG. 2 illustrates a block diagram for an example executive control flow;

FIG. 3 illustrates a block for an example baseline and control and data flow for the mission manager;

FIG. 4 illustrates a block diagram for an example software system;

FIG. 5 illustrates a flowchart for an example software system design;

FIG. 6 illustrates a block diagram for an example baseline and control and data flow design for the example software system.

FIG. 7 illustrates a block diagram illustrating an example process for ingesting data via references to qualified software identifiers;

FIG. 8 illustrates a block diagram illustrating an example process for executing branched functionality via referenced qualified software identifiers:

FIG. 9 illustrates a block diagram illustrating an example process for updating business logic via references to qualified software identifiers;

FIG. 10 illustrates a block diagram illustrating an example execution loop of a decision-making implementation; and

FIG. 11 illustrates a block diagram illustrating an example process for reordering branched functionality during runtime via qualified software identifiers.

### DETAILED DESCRIPTION

Computer software executes the compiled control flow in order, evaluating Boolean and logical operations to make decisions. These are common low-level abstractions in most programming languages, resulting in the creation of branching control flow via “IF” or switch-based implementations. These logical operations compare variable data to determine which branch of software control flow to execute during runtime.

The resulting software executed following a branching decision point is differentiated—the executed functionality results in related but different results. In even the most carefully managed software system, the sum of functionality executed after all branching decision points are frequent sources of errors or unintended results.

In large-scale, distributed, and/or mission/safety critical software systems, the complex interactions between multiple discrete branching decision points and the branched functionality can hinder the ability to confidently verify and validate the deterministic operation of the software system. This has resulted in a demonstrated need to centralize the decisions made throughout a software system such that the total sum of all combinations of decisions can be formally verified.

This is to say, determinism in a software system can be more easily verified and validated as the decisions made in the software system become more centralized.

This has resulted in the development of centralization strategies, and generic implementations of decision-making functionality. In order to effectively utilize a generic decision-making strategy in one of the above mentioned software systems, the implementation must be aware of the specific data within the software system over which the implementation is to make decisions and execute the resulting branched functionality.

In software systems, a common design is to statically allocate the memory which is to be used to represent the data across the system. This produces a block of program memory which will not change across the execution of the software system. Heritage implementations of decision-making strategies have relied solely on these blocks of program memory to enable the decision making functionality. This enables the branching logic over which the implementation is to make decisions and execute branched functionality to be updated during the execution of the software system, since the memory address of data can be controlled to be consistent throughout execution.

However, the reliance on defined blocks of program memory hinders the design of the software system—since the memory address of all data involved in the decision-making process must be known prior to the time of compilation, all data must be defined in a block and/or data structure available in the program global memory. Irregularities in the definition of that block/data structure can complicate the successful use of the implemented decision-making strategy, and a verified complete and correct reference to the entire block of memory must exist outside the software system to appropriately update the branching logic.

This limitation on software system data design and architecture is very restrictive. Typical object-oriented design methodologies will be significantly less viable, as the data access patterns typical of object-oriented data structures, such as getter and setter functions, and the lack of control over the memory layout of the objects create unnecessary hurdles to satisfying the need for a contiguous, known at compile time block of memory representing the data in the software system.

In addition, reliance on memory addresses for data access restricts any centralized decision-making implementation from utilizing more complex interfaces commonly used in modern programming languages. Many industry standard software safety constraints disallow the use of function pointers, which could otherwise allow a centralized decision making implementation to utilize function calls gathering data over which to make decisions, and to provide software systems more flexibility in the definition of functionality executed as a result of a branching decision point.

The desire to remove the above referenced constraints placed on software systems utilizing centralized decision-making implementations led to the method disclosed herein. The approach taken by the present disclosure abstracts away the need for specific memory layouts, allowing flexibility in software system design, and for the inclusion of complex software system interfaces such as function calls in the ingestion of data for decision making and to be directly executed because of centralized branching decision points.

This is achieved by relying instead on more abstract software constructs, qualified software identifiers. Qualified software identifiers, e.g., variable or function names, do not change throughout the execution of the software, and are also available prior to the time of compilation. By replacing portions of the methods used to define business logic and specify resulting functionality of decision points with qualified software references, a software system user may no longer need to maintain a consistent definition of the memory map of the software system, no longer ensure the definition of an update to business logic or functionality correctly references memory addresses, and may no longer be prevented from utilizing more complex software interfaces.

For data input to a centralized decision-making implementation, business logic can be parsed and software interfaces can be synthesized to gather the necessary data from the defined qualified software identifiers. During the execution of the decision-making implementation, the nominal execution cycle would begin by ingesting data over the defined interfaces via the qualified software identifiers (for those which are functions), and then execute the business logic defining decision points over the ingested data and the qualified software identifiers representing global data. This data does not need to be defined in any specific memory layout or software system architecture, all that is now required for compilation and successful execution of business logic is that the qualified software identifiers representing global data and input interface functions are accessible to the decision-making implementation through the program data in the software system. In C or C++, this is equivalent to including the header file where the qualified software identifier is defined in the include tree for the decision-making implementation.

The business logic and resulting branched functionality may no longer be restricted by the definition of the memory layout and software system data architecture. Thus, updates can be specified using the qualified software identifiers of software system data, which can replace the initial definition of the business logic and resulting branched functionality during runtime. Since the initial successful compilation of the business logic and resulting branched functionality within the decision-making implementation ensures the availability of those qualified software identifiers, the definitions of the decisions to be made and the functionality resulting from those decisions can be changed in any combination if the updates only reference the qualified software identifiers in the initial compilation.

For the purposes of defining updates to business logic and branched functionality, users of software systems which contain a centralized decision-making implementation only may ensure they do not reference qualified software identifiers that were not provided to the decision making functionality during the initial successful compilation that is executing. There is no longer a need to ensure the correct memory addresses are referenced.

The additional flexibility in definition of business logic enables the use of non-global data and object-oriented paradigms using qualified software identifiers for data access functions. Data can be gathered from global qualified software identifiers directly, through functions which return data local to portions of an application, or through functions which return data contained within an object.

The additional flexibility in definition of branched functionality is more comprehensive. The ability to reference a function moves the upper limit to what can be executed as branched functionality to “anything that can be defined as a function”. This means that anything from Hello World to an entire Kalman Filter can be executed because of a branching decision point in a decision-making implementation, rather than being restricted to assignments of base data types to global variables via memory addresses.

This also enables interesting complex use-cases for decision making implementations, such as reordering the execution of an entire system. If the decision-making implementation was used to sequence the execution of all functionality in the software system, then the order of the functions referenced could be updated in any possible combination of orderings of the qualified software identifiers representing functions in the software system during execution of the software system.

The systems can be instantiated using any Turing complete programming language, though the specific language constructs in use to achieve capability parity may vary. For the sake of this description, the language constructs in C++ will be used.

The system requires several components working together. These may include a text-based list of qualified software identifiers and associated metadata, a method for ingesting the data based on qualified software identifiers, a method for executing branched functionality, and a method for updating the data structures which reference qualified software identifiers.

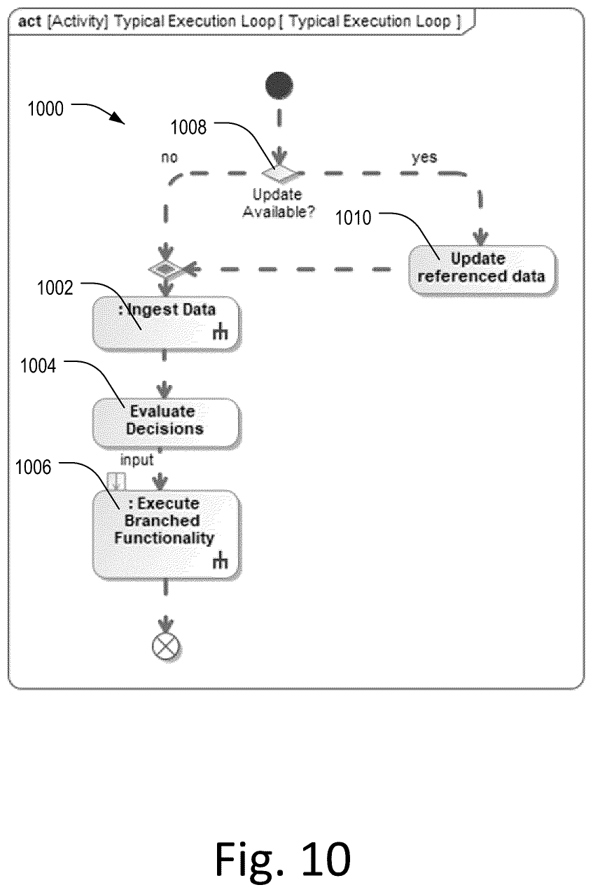

The text-based list of qualified software identifiers maps the qualified software identifiers to the data type and header file in which the qualified software identifier is declared. This list can be used to create the references which a decision-making implementation will use to make decisions. The typical execution loop of a decision-making implementation is exemplified in FIG. 10.

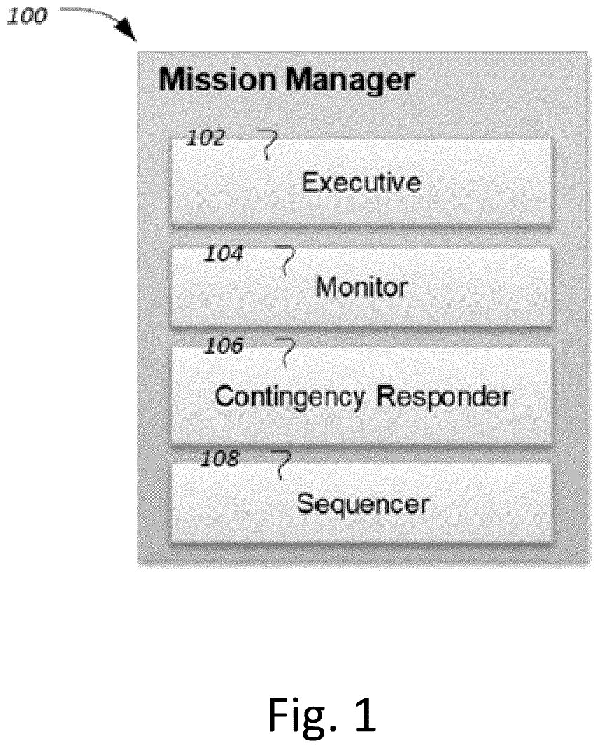

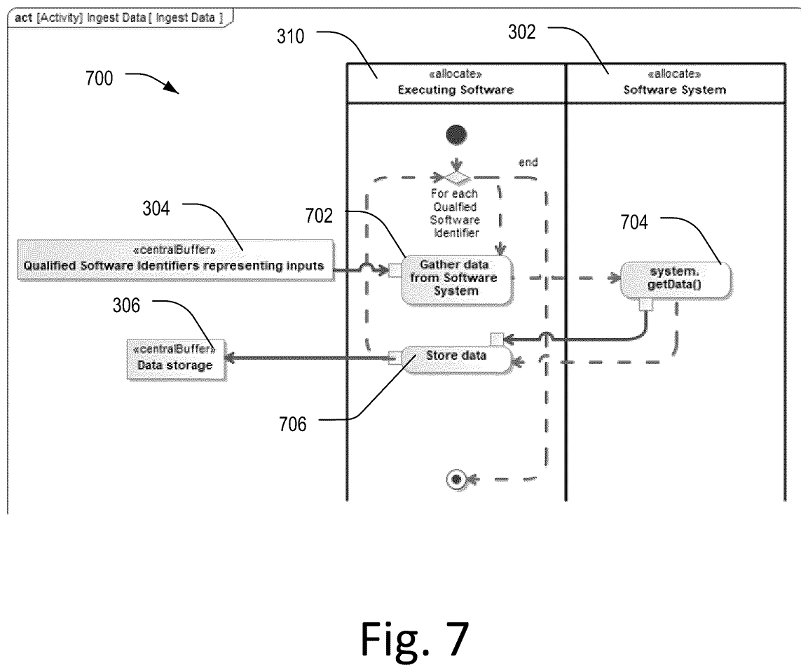

Referring to FIGS. 1-6, an example software system described herein may be implemented by ingesting system implementation data, evaluating the configured business logic defining transitions in state, mapping accepted transitions to the changes in state and system data corresponding to those transitions, and finally executing the changes in state and system data as they have been defined & accepted. This system is an example of the instantiation and usage of the processes described herein. The example software system may rely on a configuration tool to convert a system's definition of valid inputs, states, and transitions comprising parsed, categorized, and correlated qualified software identifiers into software which the example software system utilizes as its' configurable input. Such configurations may relate to qualified software identifiers derived from the executed software and the specific instantiation of the qualifiers, as discussed with respect to FIGS. 7-11 herein.

For purposes of describing the example software system herein, the below definitions are provided for ease of understanding.

State—current value or set of values for the defined system data.

Transition—criteria for acceptance of change from one state to another.

Interface—any software with a common syntax—API-like.

System—the stakeholder software which is to be managed by the example software system.

CSC—Computer Software Component. An aggregation of software that satisfies an end use function.

Command & Data Handling—The public data interface for a generic system. A wrapper around the system which provides public read access to internal state information. It may also provide public write access to CSC input data, configuration parameters, and software states.

Memory Map—the memory layout of data for a specific System Software Application.

System Execution Loop—The stakeholder specific System Application Concept of Operation. This dictates the cyclical execution of the System Software.

Each system CSC may contain a distinct portion of desired functionality, contained within separate modules. These CSCs may each implement a consolidated interface providing access to their internal states.

An example software system described herein can be configured to perform software state management, fault detection, isolation and recovery, condition monitoring, and the dispatch of changes to system data. These capabilities may be performed through a common interface that can be integrated with any stakeholder software, such as with a real time operating system (RTOS) or a manual user-in-the-loop software system.

FIG. 1 illustrates a block diagram of a design mission manager 100 including an executive block 102, monitor block 104, responder block 106 and sequencer block 108. The executive block 102 may be developed as needed for the program based on other system decisions such as the execution rates, commanding rates, command formats, and required states. The monitor block 104 may contain a reverse polish notation (RPN) engine to be executed over a statically allocated table of monitors defining the business logic dictating transitions in state. The contingency responder block 106 conditionally maps triggered monitors to the appropriate response sequences. The sequencer block 108 is a table-driven mission sequencer to execute changes to system data and state.

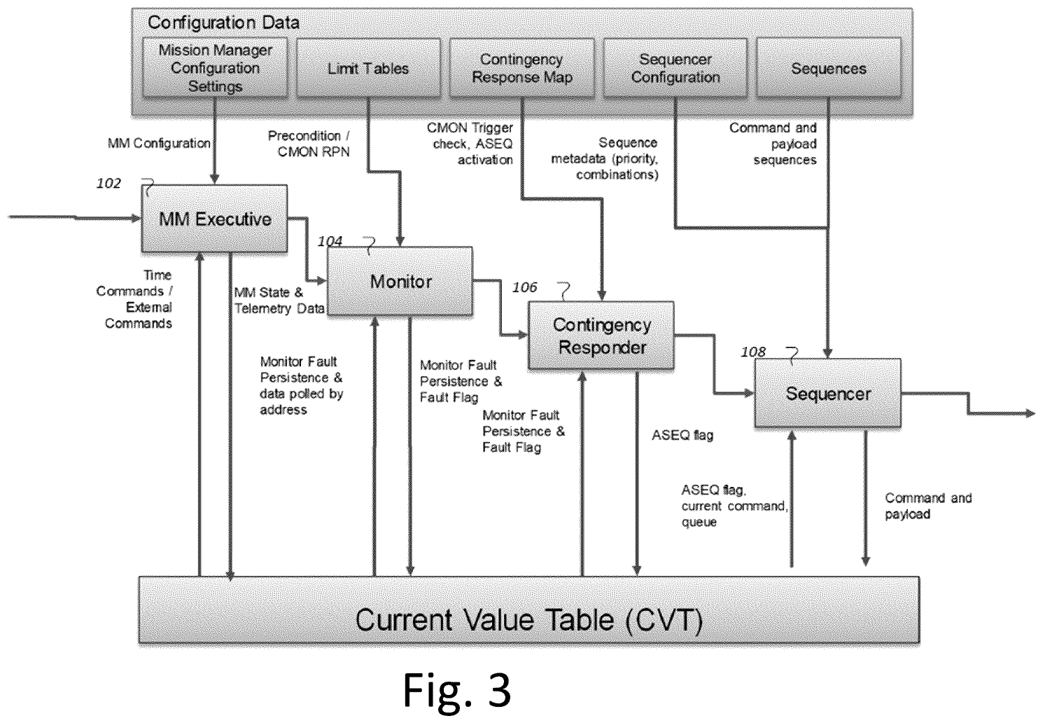

FIG. 3 illustrates an example block diagram for the baseline control and data flow in a heritage design including the executive block 102, monitor block 104, responder block 106 and sequencer block 108 of FIG. 1. The Executive CSC shall be responsible for possible rate group command handling & configuration. This may include command processing for commands such as heritage state management of Mission Management internal functionality or management of monitor/CR/sequencer by command. The rate group may also handle state and mode transitions, update configurations/flags accordingly, and perform subsystem mode updates, which may require switch to appropriate tables for monitor, contingency responder, and sequencer. The executive CSC may also perform entry point into processing, command interface with command and data handling, or act as an interface for updating current tables and related configurations.

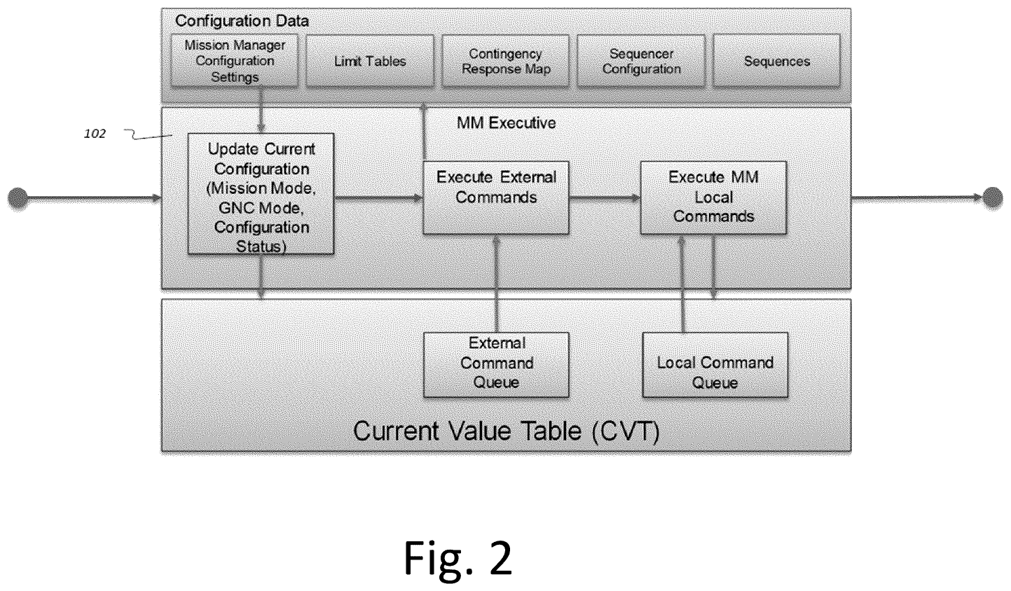

FIG. 2 illustrates an example block diagram for an executive control flow for heritage design including the executive block 102.

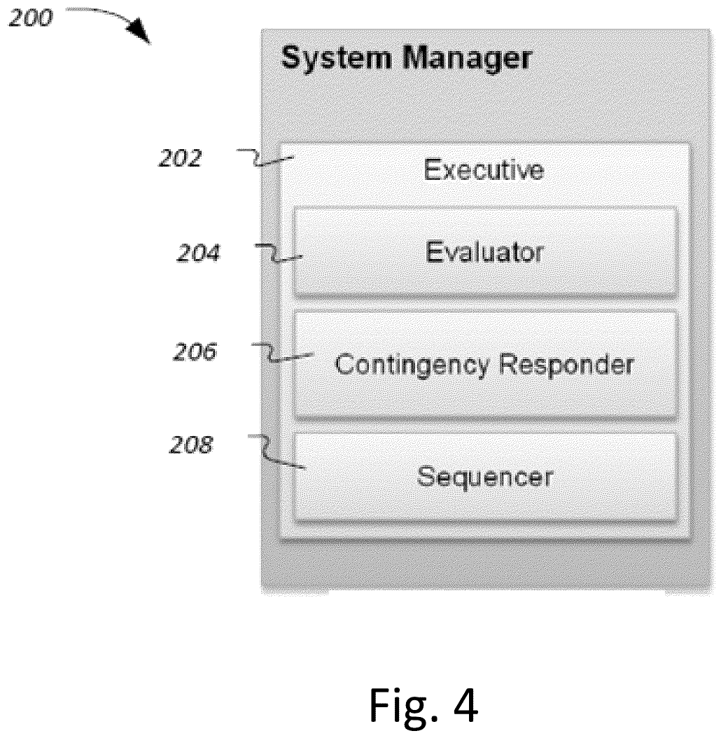

FIG. 4 illustrates a block diagram of an example software system 200 including an executive block 202 that includes an evaluator block 204, contingency responder block 206 and sequencer block 208. The example software system 200 may be built into any software application or system. The executive block 202 may handle example software system configuration and initialization/execution of other components, handle system state of operation transitions, and handle external software application input data. The evaluator block 204 may contain a RPN engine to evaluate business logic in a table-driven format. The contingency responder block 206 may conditionally map triggered monitors to the appropriate contingency response. The sequencer block 208 may perform table-driven command/message sequencing and dispatch responses, executing changes to system data, based on additional metadata, such as response priority.

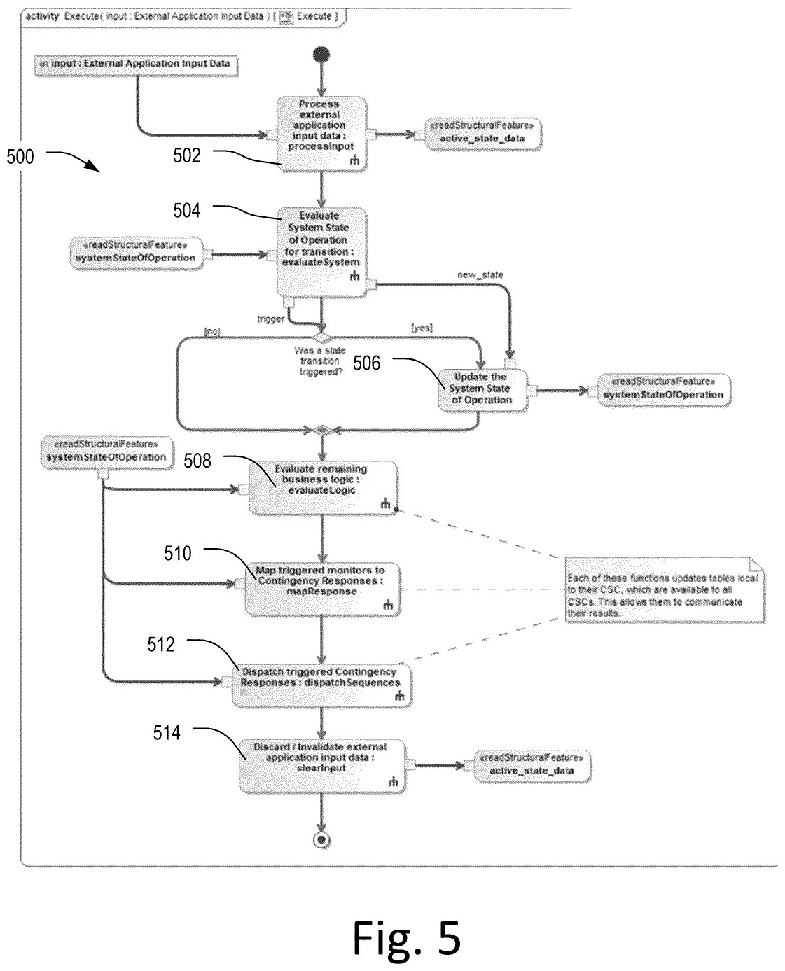

FIG. 5 illustrates an example process 500 for the example software system design where:

1. processInput—at block 502, process any data made available to the example software system (via command & message framework) from external applications and store it in local structures.

2. evaluateSystem—at block 504, perform evaluation on the business logic that defines transitions in system states of operation.

3. At block 506, in response to determining that the state transition was triggered, update the system state of operation according to the evaluated business logic.

4. evaluateLogic—at block 508, perform evaluation on the business logic defined for the current System State of Operation.

5. mapResponse—at block 510, flag responses for dispatch by the sequencer using the results of the evaluator.

6. dispatchsequences—at block 512, dispatch the configured sequences, in order of priority, based on the results of the contingency responder.

7. clearinput—at block 514, discard or invalidate all external application data input this cycle of execution.

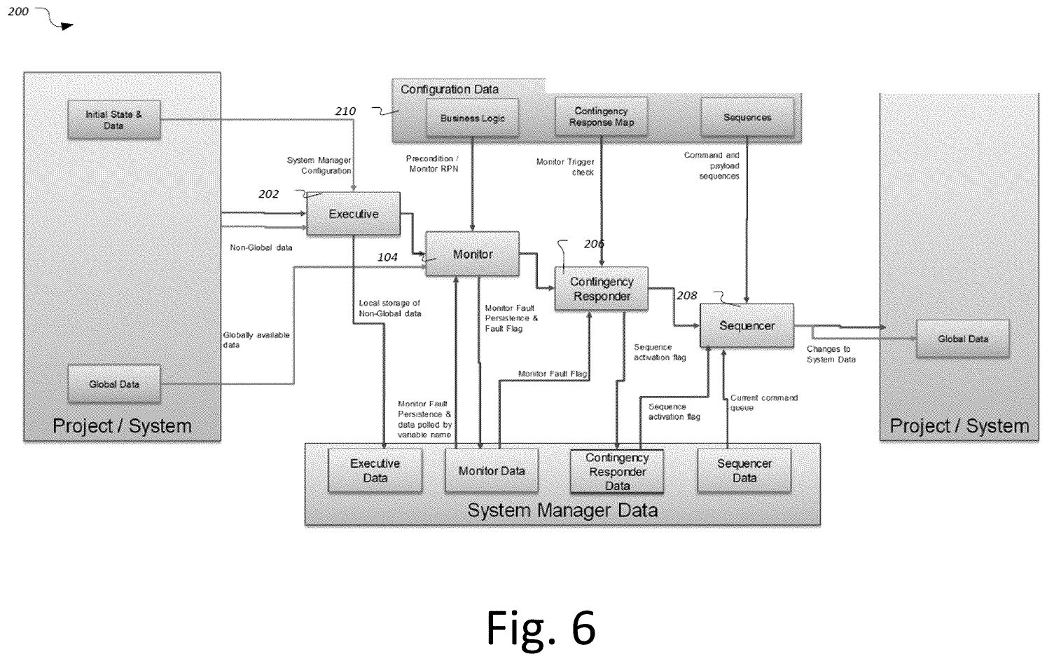

FIG. 6 illustrates an example block diagram for the control and data flow within the example software system 200 including the executive block 202, monitor block 104, responder block 206 and sequencer block 208 of FIG. 4.

The example software system architecture may include four main components. In addition to the executive block 202, monitor/evaluator block 104, responder block 206 and sequencer block 208, the example software system may rely on an external configuration tool and configurable input data.

The configuration tool may convert a system's definition of valid inputs, states, and transitions in state to data structures which can be compiled with the example software system into a system's executable software and parsed during run-time execution. The configurable input is a set of human-readable software adjacent files, metadata about the stakeholder specific system data, which contain a system's definition of valid inputs, states, and transitions in state. This is possible because programming languages have well defined syntax, so with a small subset of information on the system's application software data definitions, including the software location of the declaration of system inputs and data involved in transitions, human-readable states and transitions can be easily defined and compiled for integration with the execution of the example software system functionality.

The executive module or executive block 202 may manage the ingestion of system data according to the compiled configuration, the initialization and execution of its sub-modules (evaluator, contingency responder, sequencer), the flow of data between each sub-module, and the transitions in the highest-level state machine defined. The executive module may also manage the reconfiguration of itself and its sub-modules during runtime.

The evaluator module or evaluator block 204, a sub-module of the executive, and reverse polish notation engine contained within the evaluator, may be responsible for evaluating the configured business logic during run-time execution. The business logic driving the reverse polish notation engine uses references to system data inputs, as well as any other data ingested by the executive, to evaluate the configured business logic determining transitions in state of the defined state machines.

The evaluator runtime configuration is business logic compiled from the project configuration definition, containing: qualified software names of any global data, and the name of the header file containing the data structure; qualified software names of any message and/or command data provided to the example software system, the name of the header file defining the message/command, the name of the header file containing the data structure; and logical operations to be evaluated between defined qualified software names and/or constant values.

The configuration tool will compile this project configuration into a reverse polish notation business logic definition, as well as data structures local to the example software system to hold external application input data while it is being evaluated.

The contingency responder module, block 206, a sub-module of the executive, may map triggered sets of business logic; the logic governing transitions which are found to evaluate “true” during a given cycle of execution; to the configured set of contingency responses; transitions in state and/or system data—the activated set of transitions in state and system data are then made available to the Sequencer Module.

The contingency responder runtime configuration may be a mapping of monitors to defined contingency responses; transitions in state and/or system data. Project configuration may define responses to activated monitors, including any messages, commands, or changes to external application state data that might occur because of an activated monitor. This response sequence may be a single message/command with parameters, a single qualified software name of external application state data globally available to the example software system and an updated value, or an array of any combination of these. Each response sequence will have a priority to add to the flexibility of the sequencing capability.

The project configuration may also map responses to specific monitors. This may be one monitor to one response, or many monitors to many responses. For example, “Battery one has failed, switch to battery two” or “Battery one has failed and Solar Array two has failed, switch to external fuel source.” The configuration generation tool may also compile this project configuration into two tables including a table mapping monitors to responses and a table defining responses.

The sequencer module, block 208, a sub-module of the Executive, may act as the output interface between the example software system and the system application software, responsible for executing changes throughout the system based on the results of the mapping in the contingency responder. Due to the flexibility of the configurable input, the sequencer can execute changes over a software interface that has a common syntax—this is to say, any communications or command & data handling protocol which has a regular syntax can be configured as an interface over which the sequencer module can enact changes in state or system data. This may include any interface which has been defined appropriately in the configurable input.

The project configuration may define the interface for the sequencer block 208 to communicate with the rest of the system. The configuration generation tool may combined with the qualified software names in the Evaluator configuration, compile this project configuration into an interface to execute changes across the stakeholder project such as: send messages/commands, make direct changes using system getter/setter functions, or make direct changes to globally available data. This interface is likely to be software architecture specific and may need a “wrapper” added to the system application software to correctly define the communication protocol with the rest of the system application software.

A configurable input block 210 may include logic, maps, and sequences. By defining transitions as business logic, ensuring the input logic will evaluate to a Boolean TRUE or FALSE, and restricting the input data defining these transitions to the subset of system data specified by the user, the configured business logic may be compiled to post-fix notation by the configuration tool, and the order of operations, as well as the values input to those operations, can be synthesized as code to be run through a generic reverse polish notation evaluation engine.

Combinations of monitors and mappings may be used to add flexibility and the possibility for additional complexity to the example software system determination capabilities. When a defined transition returns TRUE, it could be used in conjunction with other transitions to define a separate transition which exists as a super-set of multiple other transitions. In this way, multiple otherwise discrete states and state machines can be joined.

This mapping is simpler for a user to define than the configuration of heritage Mission Management applications and may include a list of transitions where the size is always greater than or equal to 1 transition, which corresponds to an index into the defined response table.

Responses are the most flexible and powerful portion of the example software system. A response may use defined system data as endpoints—the example software system cannot make changes to data which has not been made available to it. The example software system is compatible with any system interface which has a common syntax—if the interface can be synthesized regularly, all that is required is a specific definition in the configuration and, as necessary, a corresponding special-case for the interface in the configuration tool.

The sequencer, or sequencer block 208, may output values to system data. This may be the actual change in “state” for the system data, triggered by the combination of business logic evaluation and the mapping configured for the contingency responder.

Said another way, the configuration tool may compile the business logic. Specifically, projects may define a system state machine, as well as the valid transitions between those system states of operation. This may be the basic determination capability. The system may contain enumerators for every valid system state of operation and business logic defining all valid transitions between those system states of operation. That is, the system may define and evaluate logic on any data made available to the example software system.

Projects may define business logic for any other cases they wish to monitor in the system. This may be the fault detection, isolation and recovery (FDIR)/complex determination capability. The business logic may involve any combination of external application data or global data available to the example software system and message/command data provided to the example software system.

Characteristics of heritage implementations may retain robust scripting capability, flight heritage, CPU-intensive execution, limited expertise and domain knowledge, and limitations on data design (bit-level memory map). The heritage concepts may have project specific implementation of the executive, execution & commanding rates, formats, state machine definition, strict/specific command and data handling format, inclusion of time in processing, higher fidelity control over logic, and be a limiting factor in system data design.

The example software system concepts may be generic to specific system software application architecture and have configurable State Machine management. That is, the example software system concepts are not tied to any specific data design or command and data handling format, and offload burden of mission or system specifics to configuration. There is no formal mission scripting format, though the current implementation constrains the definition of input via a formal syntax. The current implementation is reliant on low-level logical/math formatting & updates to data over configured interfaces. Further, the example software system concepts have logical implementation with no direct management over state of individual elements, though equivalents could potentially be handled by additional compiled configurable input. The example software system concepts are highly flexible to changes in system or use-case and may be integrated with any data design/command and data handling interface with a common syntax.

Further, another solution exists that includes a unique solution to the determinism issue for any given system—with a fully defined state machine, at all levels of execution, equivalent logic can be integrated into the specific implementation to check for transitions in state, as well as to handle these transitions appropriately in place. This solution increases the maintenance cost and decreases the reliability of the given system with respect to management of state and assurance of determinism, since all checks are either distributed amongst the source or the source is refactored/redesigned to centralize determination. This solution is highly burdensome on system and software development.

For a set of systems which share many common characteristics, a common interface could be defined to feed a semi-common state machine. This does have the obvious error—lacking specificity that may be necessary for any individual system. Like the system described above, placing system design restrictions on a project could allow for another alternative—if all data is in a global scope, available for state machine execution and management, then the implementation of a system management application could likewise be centralized. This is the approach taken by some other solutions. This approach may require that all data be in the global scope. While the example software system here may utilize data available in the global scope, in mission and safety critical systems, data that would otherwise be defined in the global scope may be encapsulated to prevent unnecessary or accidental access.

The existing solutions place upon the system the restriction that all data be globally accessible to the thread/partition in which the existing system is executing and may also require a complete memory map of all data in the global scope at the time of compilation, binary outputs, or additional restrictions on the design of the system to be integrated with a heritage mission management capability.

As a concept, the example software system removes several restrictions put in place by the existing implementations of similar capabilities. By allowing a more flexible definition of its configuration, the example software system removes the need for a system to specify all relevant data in global scope, as well as the need to specify a bit-level memory map corresponding to the accessible data, and the need for additional restrictions on the design of the system.

One aspect of the example software system also allows for much more flexible integration of software interfaces than heritage implementations. This allows the example software system to be much more flexible and achieve the determination of otherwise non-deterministic systems. For example, publication/subscription-based interfaces are notoriously difficult to determine. Real Time Operating Systems are implemented to be cyclical using time triggers, and so message-based triggering of execution can cause significant complexity in system determinism, as well as cause any effort to determinize the system to be separated over several different execution contexts.

Technically, it is difficult to integrate such a generic and abstract application as the example software system into a larger system. Fully defining the configurable inputs, as well as converting them appropriately into compile-able code, has been difficult and caused many iterations of data structures in heritage implementations. The example software system utilizes abstraction of system specific information in its' configuration to alleviate some of this difficulty.

In short, the example software system is compatible with any interface with a common syntax—that is, any interface which can be characterized by a subset of information existing in the given system (data type, function, or API declaration, etc.).

To reiterate, the example software system does not require all data be available in the global scope, which may be important for safety and mission-critical systems, does not require alignment of memory, and overall may allow a wider flexibility than existing solutions—these three constraints existed in heritage systems. The human-readable nature of the configuration is a significant improvement over the existing solutions. The most significant advantage of the example software system is its flexibility with respect to the definition of alternative interfaces. With the possible points of insertion for management of nondeterministic systems nearly endless, the example software system could act as the manager for any conceivable state machine, provided a valid and correct definition of the configuration for said state machine.

By relying on compiled configurable input data, the example software system does not need to rely on global data for input. The example software system is still compatible with globally available data but is also compatible with any software interface with a common syntax. This removes a significant constraint found within prior implementations of the Mission Management capability and lessens the impact of design constraints in place on a System Application Software CSC due to the use of the example software system when compared to heritage Mission Management Capabilities.

Due to architectural changes in the configuration and data management concepts in place within the example software system with respect to heritage implementations, the example software system does not require a bit-level memory map. The new concepts remove the heritage Mission Management capability of a memory map detailing the layout of data in memory altogether, removing yet another major constraint on a System Application Software CSC when heritage Mission Management capabilities have been used in the past.

The example software system may provide configuration and management of system internal states, handle errors which do not rely on external input to resolve, report errors which rely on external input to resolve, and prevent further degradation of system performance or output; provide control over data and execution flow to and from system modules, report system module internal state data (read only), and provide a user-friendly interface to system determination.

FIG. 7 illustrates a block diagram illustrating an example process for ingesting data via references to qualified software identifiers. As exemplified in FIG. 7, the example process 700 for ingesting data based on qualified software identifiers will include gathering and parsing data from the software system for each qualified software identifier. Generally, the software system 302 will copy data from qualified software identifiers into the software system 302 to the local data set at the executing software 310. This may allow a decision-making implementation to be able to reference the qualified software identifiers. Qualified software identifiers referencing variables in global software system namespace does not need to be copied and can be referenced in-place by a business logic evaluator.

The process 700 may include task execution by the software system 302 prescribed by the executing software 310. The executing software 310 may receive qualified software identifiers 304 representing data inputs from the software system 302 and at block 702, will ingest said qualified software identifiers 306. At block 704, the software system 302 may be executed as prescribed by the executing software 310 to gather the data values at the references qualified software identifiers 304 within its' state. The data values are then provided to the executing software 310, which stores the specific data values in the data storage of the executing software 310 in block 706 for usage in the implemented functionality in the executing software. This implemented functionality may be a decision making capability. This implemented functionality may also be a task execution capability.

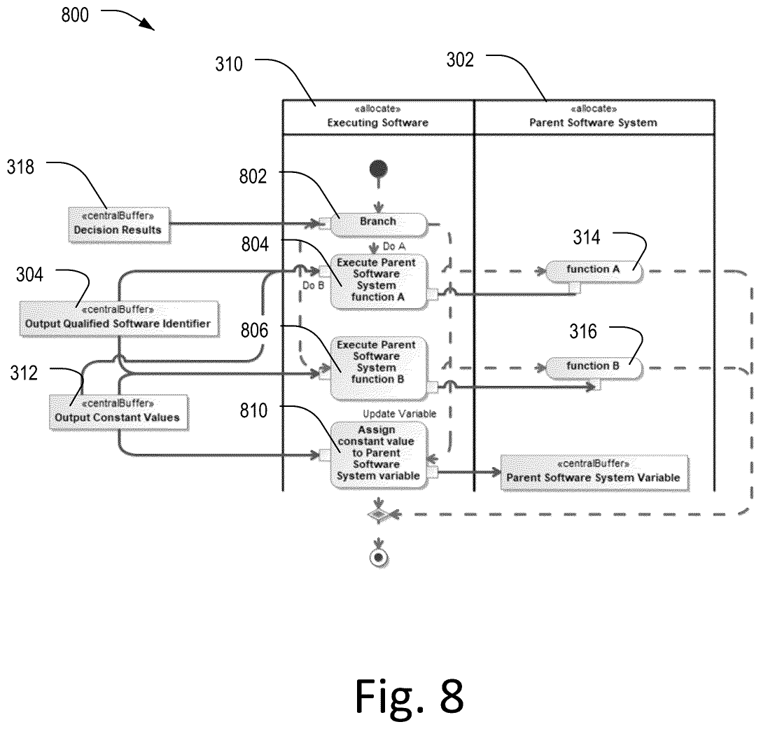

FIG. 8 illustrates a block diagram illustrating an example process 800 for executing branched functionality via referenced qualified software identifiers. As exemplified in FIG. 8, the method for executing branched functionality will implement a branching strategy to execute functionality resulting from the decisions made by a decision-making implementation. This is implemented by using a switch statement to branch based on the abstracted reference to a qualified software identifier if that software name is a function, or on the abstracted reference to a specific combination of a constant/variable to be assigned to a qualified software identifier representing a software system variable and the qualified software identifier representing the software system variable.

Specifically in FIG. 8, decision results 318 may be received by block 802. Block 802 may instruct according to the decision results 318 to execute function A at block 804 or to execute function B at block 806, or to perform a variable update in the Parent Software System. As specified by the branching block 802 dependent upon the decision results block 318, blocks 804 and 806 may receive the qualified software identifiers 304. Blocks 804 and 806 may also receive output constant values 312 to specify particular arguments according to the syntax for the function interfaces defined by the qualified software identifiers block 304. The branch at block 802 may also assign instruct according to the decision results 318, to assign constant values to the variables at block 810. Block 810 may also receive the output constant values 312 and use these to assign constant values. Block 810 may provide an interface for assignment to system variables 320 resident within the Parent Software System 302 from within the Executing Software 310. Blocks 804 and 806 may provide interfaces to prescribe execution of function A 314 and function B 316, resident within the Parent Software System 302, to the Executing Software 310, respectively.

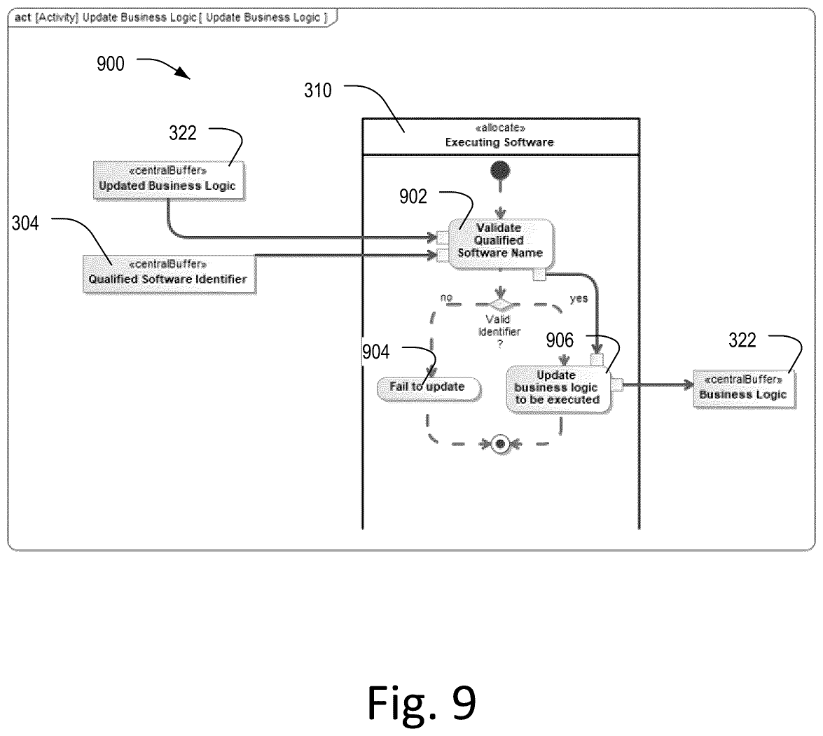

FIG. 9 illustrates a block diagram illustrating an example process 900 for updating business logic via references to qualified software identifiers. As exemplified in FIG. 9, the method for updating or reconfiguring the data structures which reference qualified software identifiers will verify the qualified software identifiers are valid using abstract references to the qualified software identifiers to avoid runtime errors. It then will update the tables housing qualified software references to drive the methods for executing branched functionality and ingesting data, copying via abstract references to the qualified software identifiers or the abstracted enumerated values which can be used to branch functionality as appropriate. That is, the order of execution is reliant on the prescribed order via decisions made, and that the order can be changed.

The executing software 310 may receive updated business logic 322 at block 902 as well as the qualified software identifiers 304. At block 902, the executing software may validate the qualified software identifiers 304 using abstract references to said qualified software identifiers 304. This may include verifying that the name of the identifier is present in the Executing Software 310, and that the type of data and source of data are also present. For a function, this may also require that the identifier includes the syntax and argument list.

If the qualified software identifier is not validated, the process 900 proceed to block 904 and if the qualified software identifier is validated, the process 900 proceeds to block 906, where the business logic 322 is updated. At block 904 the business logic is not updated.

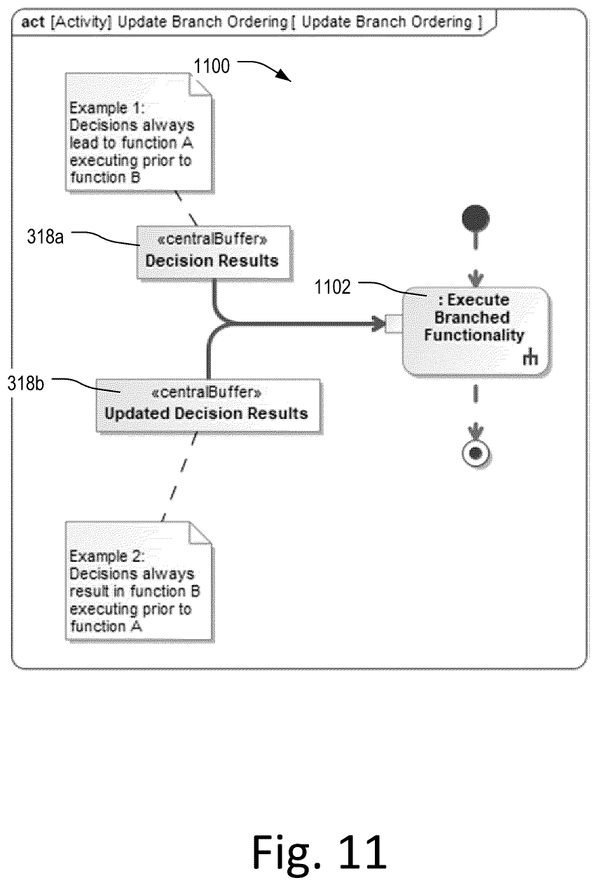

As the branching functionality exists regardless of the specific decisions made, and relies on the decisions made, the order in which the qualified software identifiers are referenced based on decisions made can be updated while the software system is executing, as exemplified in FIG. 11.

FIG. 10 illustrates a block diagram illustrating an example execution loop 1000 of the exemplified implementation. This loop 1000 may include, at block 1002, ingestion and parsing of qualified software identifiers from the software system and categorization of the qualified software identifiers. This categorization may include identification the qualified software identifiers as a variable or a function. The loop 1000 may also correlate the qualified software identifiers with at least one constraint defined by the categorization. The constraint may define business logic and may define what can be done, such as task execution or variable assignment, with the resulting list of qualified software identifiers. Business logic may include a logical or Boolean comparison between the referenced data residing in the executing software. In one example, the business logic may define that a variable cannot be compared a variable.

The loop 1000, at block 1004 may evaluate decisions based on the parsed, categorized, and correlated qualified software identifiers. This evaluation may define the order of execution of the qualified software identifiers based on the constraint or constraints defined by the decisions. This evaluation may also rely on business logic, and may include certain constraints or checks, such as check for power on, check for sensor on, etc. Based on these decisions and outcomes, the example software system may execute tasks in an order based on the defined constraints and qualified identifiers of tasks.

The loop 1000, at block 1006, may then execute the tasks defined by the example software system according to the generated order determined in block 1004. This may include executing functions A and B, as set forth by way of examples in FIGS. 7, 8, and 11.

The loop 1000, at block 1008, may then determine if there is a need arising during the execution of the software system for reconfiguration of the order of execution or the business logic. This may include a detected fault in the executing software system from which business logic can be defined built from qualified software identifiers to isolate the fault and/or recover from the fault. This may include an expected change (non-fault) in the state of the qualified software identifiers representing variables in the executing software system from which business logic can be defined built from qualified software identifiers to prescribe the appropriate response to the expected change. This may include an unexpected change which would otherwise result in undefined or unwanted behavior within the executing software system, from which business logic can be defined built from qualified software identifiers to isolate the unexpected change and/or recover from any negative effects on the executing software system through a subsequent change to the prescribed behavior/task to be executed. This may also include results from the executing being negative, or falling outside of an expected or predefined threshold. This may include calibration of certain system etc. The loop 1000 may determine whether or not updates or reconfigurations are available and may update the reference data at block 1010. Upon the updating, the loop 1000 may proceed to execute the tasks defined by the reconfiguration of the order of the qualified software identifiers and proceed to block 1002 and continue the loop. Thus, updates can be specified using the qualified software identifiers of software system data, which can replace the initial definition of the business logic and resulting branched functionality during runtime. Notably, in addition to updating the order, other reconfigurations may be included, such as updates to the business logic.

FIG. 11 illustrates a block diagram illustrating an example process 1100 for reordering branched functionality during runtime via qualified software identifiers. In this example, the software system may execute branched functionality based on a first set of decision results 318a. In this, by way of example, function A may be performed prior to function B. However, the updated decision results 318b may include an order where function B being executed prior to function A. The updated decision results 318b may be implemented to the functionality at block 1102 while the block 1102 is carrying out the functions according to the first decision results 318a.

Computing devices described herein generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A method for reconfiguring data referenced during the execution of a software system without the need for prior knowledge of a structured memory layout of the software system, comprising:
parsing qualified software identifiers from the software system and categorizing the qualified software identifiers as either functions or variables, each associated with a name, data type, and data source;
correlating the qualified software identifiers with at least one constraint defined by the categorizing;
generating an order of execution of the qualified software identifiers based on the constraint;
executing tasks defined by the software system according to the order of the qualified software identifiers;
in response to a need arising during the execution of the software system, reconfiguring of the order of execution of the qualified software identifiers; and
executing tasks defined by the reconfiguration of the order of the qualified software identifiers.

2. The method of claim 1, wherein the at least one constraint is based on a business logic including logical or Boolean comparisons between referenced data residing in the software system;

3. The method of claim 2, wherein the reconfiguration includes reconfiguration of the business logic.

4. The method of claim 1, wherein the reconfiguration includes changing the order of execution of functions defined by the qualified software identifiers.

5. The method of claim 1, further comprising validating the qualified software identifiers.

6. The method of claim 5, wherein the validation includes determining that each qualified software identifier is associated with a valid name, data type and data source.

7. The method of claim 1, wherein the reconfiguration of the order in which qualified software identifiers representing functions are executed is completed during execution of the software system.

8. A method for reconfiguring data referenced during the execution of a software system without the need for prior knowledge of a structured memory layout of the software system, comprising:
parsing qualified software identifiers from the software system and categorizing the qualified software identifiers as either functions or variables, each associated with a valid name, data type, and data source;
correlating the qualified software identifiers with at least one constraint defined by the categorizing;
generating an order of execution of the qualified software identifiers based on the constraint; and
executing tasks defined by the software system according to the order of the qualified software identifiers.

9. The method of claim 8, further comprising, in response to a need arising during the execution of the software system, reconfiguring of the order of execution of the qualified software identifiers.

10. The method of claim 9, further comprising, executing tasks defined by the reconfiguration of the order of the qualified software identifiers.

11. The method of claim 10, wherein the reconfiguration includes changing the order of execution of functions defined by the qualified software identifiers.

12. The method of claim 8, wherein the reconfiguration of the order is completed during executing of the tasks.

13. The method of claim 8, wherein the at least one constraint is based on a business logic including logical or Boolean comparisons between referenced data residing in the software system.

14. The method of claim 13, wherein the reconfiguration includes reconfiguration of the business logic.

15. The method of claim 9, further comprising validating the qualified software identifiers.

16. The method of claim 15, wherein the validation includes determining that each qualified software identifier is associated with a valid name, data type and data source.
